(19) United States
(12) Patent Application Publication
(10) Pub. No.: US 2007/0072720 A1
(43) Pub. Date: Mar. 29, 2007

(54) Silent chain

(75) Inventor: Kenichi Nagao, Osaka (JP)

Correspondence Address: HOWSON AND HOWSON, SUITE 210, 501 OFFICE CENTER DRIVE, FT WASHINGTON, PA, 19034, US

(73) Assignee: Tsubakimoto Chain Co., Osaka (JP)

(21) Appl. No.: 11/503,604

(22) Filed: Aug. 14, 2006

(30) Foreign Application Priority Data
Sep. 26, 2005 (JP) 2005-278617

(51) Int. Cl. F16G 13/04

(52) U.S. Cl. 474/213; 474/212

(57) ABSTRACT

In a silent chain, the joint row link plates and the connecting pins are subjected to barrelling to improve the smoothness of their contacting surfaces and thereby achieve improved lubrication by an oil film. The edges of the pin holes in the plates are also rounded or chamfered by barrelling to reduce contact pressure when the joint row plates become tilted relative to the connecting pins.

### CROSS-REFERENCE TO RELATED APPLICATION

This application claims priority on the basis of Japanese patent application 2005-278617, filed Sep. 26, 2005. The disclosure of Japanese application 2005-278617 is hereby incorporated by reference.

### FIELD OF THE INVENTION

This invention relates to silent chains of the kind used to transmit rotation from a drive sprocket to one or more driven sprockets, and more specifically to the suppression of elongation of a silent chain by reducing wear of the chain's connecting pins.

### BACKGROUND OF THE INVENTION

A silent chain is a well-known type of drive chain, comprising link plates, interconnected in articulating relationship, and arranged to form a closed loop. Each link plate has a pair of teeth and a pair of pin holes. The link plates are arranged in alternating rows, each row extending widthwise of the chain. The respective rows are referred to as “joint rows,” which consist of link plates, and “guide rows,” which consist of link plates and guide plates, the latter being disposed at both ends of a guide row and being capable of contacting the sides of sprocket teeth in order to prevent the chain from disengaging from a sprocket. The plates of the alternate joint rows and guide rows are interleaved and connected by connecting pins which are fixed to pin holes formed in the guide plates, but fit loosely through the pin holes in the link plates. The silent chain bends as it engages, moves around, and disengages from, a sprocket. As this bending takes place, wear can occur in the a pin holes and in the connecting pins. A known approach to the reduction of wear is to improve the roundness of the inner circumferential surfaces of the pin hole and the surfaces of the connecting pins, and to utilize a vanadium carbide outer layer on the pins, as disclosed for example in European Patent Specification EP 0 982 515.

An example of a silent chain is shown in FIG. 2. A link plate A from a joint row is shown in FIG. 3, a link plate 8 from a guide row is shown in FIG. 4, and a guide plate 10 is shown in FIG. 5. Connecting pins 12 fit loosely into pin holes 3 of the link plates 4 in the joint link rows 5 and into pin holes 7 of the link plates 8 disposed in the guide link rows 11. The ends of each of the connecting pins 12 fit into pin holes 9 of a guide plate 10 disposed on outermost ends of the guide link rows.

In this silent chain 1, the joint link row 5 pivots freely about the connecting pin 12. Thus, the joint link rows and the guide link rows are free to articulate relative to each other about the connecting pins 12.

When the silent chain 1 flexes as it engages and disengages a sprocket, the pin holes 7 of the guide row link plates 8 do not rotate about the connecting pins 12. However, the pin holes 3 of the joint row link plates 4 rotate on the connecting pins. When the chain flexes, the joint row link plates 4 can become tilted out of perpendicular relationship with the connecting pins, as illustrated exaggeratedly in FIG. 6.

As the plates 4 tilt, edges 3b of the pin holes 3 can come into contact with the connecting pins 12, applying a large, localized pressure to the surfaces of the connecting pins, causing excessive wear in the pins, which results in wear elongation of the chain. This problem exists even when the pressure at the relatively sliding surfaces of the pin holes and the connecting pins is reduced by decreasing the surface roughness of the inner surfaces of the pin holes and the surfaces of the connecting pins.

Furthermore, whereas in the case of a roller chain, the connecting pin is typically in sliding contact with a bushing over a wide area, in the case of a silent chain, the joint row link plates are thin, and contact the connecting pins over a small contact region. Consequently, the surface pressure acting between the pinholes and the connecting pins is large. Resulting wear of both the pin hole and the connecting pins also contributes significantly to wear elongation of the chain. The reason for this wear is illustrated in FIG. 7(A), which shows the surface of a pin hole 3, consisting of concave and convex portions, and the surface of a pin 12, also consisting of concave and convex portions. The inner circumferential surface of the pin hole 3 in a joint row plate and the outer circumferential surface of a connecting pin 12 come into direct metal-to-metal contact. During operation of the chain, when lubricating oil is supplied to the chain, spaces formed by the concave and convex portions are larger than the film thickness of the lubricating oil. A condition known as “boundary lubrication” occurs, in which lubrication is inadequate, and portions of the pin hole and portions of the connecting pin come into direct contact with each other. This condition results in excessive loss of material through wear.

Accordingly, objects of the invention include the solution to the above-mentioned problems, and the provision of a silent chain in which, when joint link plates tilt with respect to a connecting pin and the chain is flexed, the surface pressure at the edges of the pin holes in the joint link plates does not increase greatly, wear of the connecting pin is suppressed, and wear elongation of the chain is reduced. It is also an object of the invention to provide a silent chain in which the sliding surfaces between the pin holes of the joint link plates and the connecting pins are flattened, so that wear of the pin holes and the connecting pin is further suppressed, and wear elongation of the chain is further reduced.

### SUMMARY OF THE INVENTION

In the silent chain in accordance with the invention, joint row link plates, each having a pair of teeth and pin holes, are disposed in joint link rows, guide row link plates, each having a pair of teeth and pin holes, are disposed in guide link rows, guide plates, each having a pair of pin holes, are disposed at opposite ends of each guide link row, and the link plates of the joint link rows and the plates of the guide link rows are interleaved, and connected, by connecting pins disposed in the pin holes, to form a chain in the form of an endless loop. The pin holes of the joint row link plates have inner circumferential surfaces with opposite ends in the form of circular edges, which are chamfered or rounded, preferably by barrelling of the link plates. The barrelling process can also be used to reduce the surface roughness of the inner circumferential surfaces of the pin holes of the joint row link plates as well as the roughness of the outer circumferential surfaces of the connecting pins. Another aspect of the invention is a method of making a silent chain comprising chamfering or rounding the ends of pin holes in link plates by barrelling, and incorporating the link plates, as joint row link plates, into a silent chain.

Since the edge portions at both ends of each pin hole in the joint row link plates are chamfered or rounded by barreling of the link plates, when the link plates become tilted with respect to the connecting pins, the contact area between the edges of the pin holes and the connecting pins is increased, and consequently, the contact pressure is reduced. As a result, wear of the connecting pin is reduced, and wear elongation of the chain is suppressed.

When the smoothness of the inner circumferential surfaces of the pin holes and the outer circumferential surfaces of the connecting pins is improved by barreling, an improved lubricating oil film is easily formed, which reduces contact pressure, and suppresses wear of the connecting pins and the pin holes. This measure also suppressed wear elongation of the chain. Preferably, the circumferential surfaces are made smooth by barelling, and the edges of the pin holes are also chamfered or rounded. When both measures are taken, wear elongation is suppressed even if the joint row link plates become tilted with respect to the connecting pins.

### BRIEF DESCRIPTION OF THE DRAWINGS

FIG. 1 is cross-sectional view of a portion of a silent chain according to the invention, exaggerated to illustrate the function of the invention;

FIG. 2 is a perspective view of a part of a silent chain according to the invention;

FIG. 3 is a side elevational view of an inner link plate of the chain;

FIG. 4 is a side elevational view of an intermediate link plate;

FIG. 5 is side elevational view of a guide plate;

FIG. 6 is an exaggerated cross-sectional view, corresponding to FIG. 1, of a portion of a conventional silent chain; and

FIGS. 7(A) and 7(B) are schematic views illustrating the sliding conditions between a connecting pin and a pin hole before and after barreling, respectively.

### DETAILED DESCRIPTION OF THE PREFERRED EMBODIMENTS

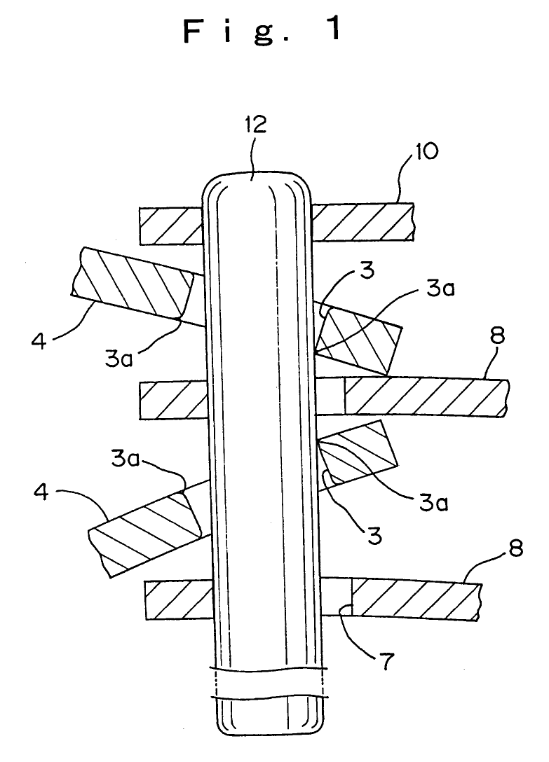

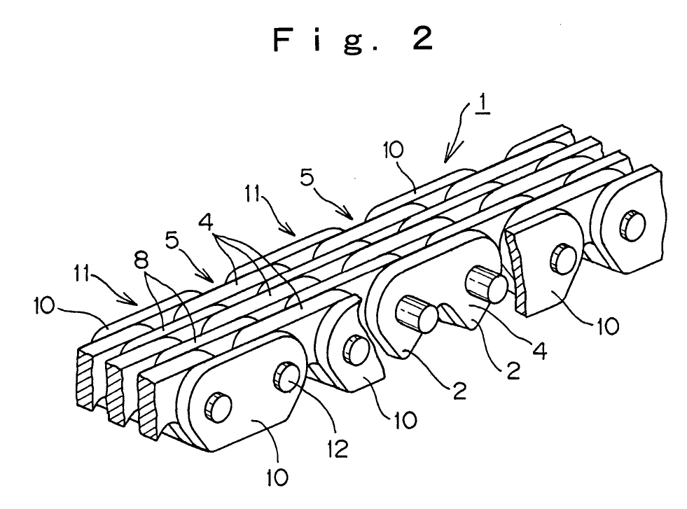

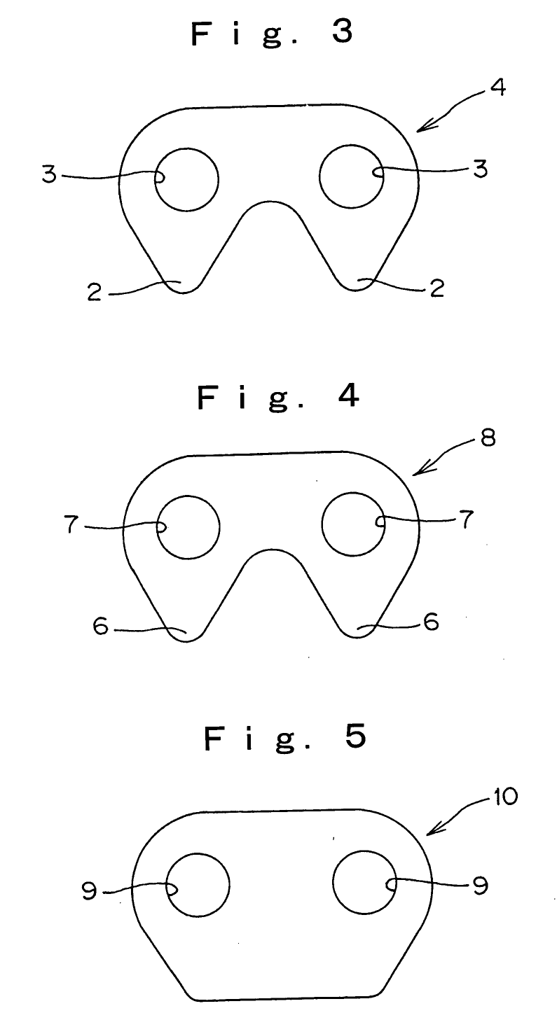

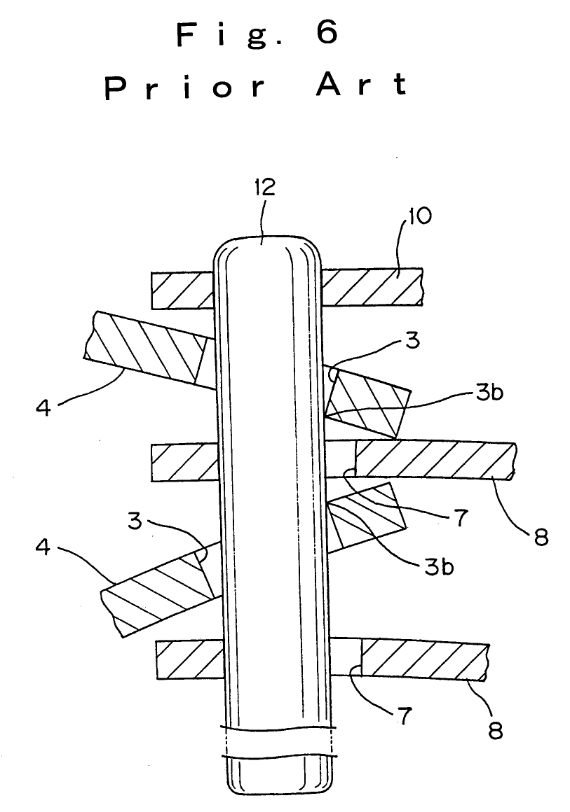

As shown in FIG. 1, a silent chain 1 comprises a plurality of joint link plates 4, each having a pair of teeth 2 and a pair of pin holes 3 as shown in FIG. 3. The joint link plates 4 are disposed in a joint link row 5 extending widthwise of the chain. The chain also comprises guide link plates 8, which have teeth 6 and pin holes 7 as shown in FIG. 4. These guide link plates are disposed in a guide link row 11. Guide plates 10, each having a pair of pin holes 9, as shown in FIG. 5, are disposed at both ends of each of the guide link rows 11. The plates of the joint link rows are arranged in alternation with the plates of the guide link rows along the length of the chain, and the plates are interleaved and connected by insertion of connecting pins 12 in the pin holes so that the chain is in the form of an endless loop.

The connecting pins 12 fit loosely through the pin holes 3 of the link plates 4 and through pin holes 7 of link plates 8, but fit into pin holes 9 of the guide links with an interference fit, so that the guide plates are rigidly secured to the pins. The joint rows 5 can pivot freely on the connecting pins, and therefore, the joint rows can articulate relative to the guide rows.

As shown in FIG. 1, edges 3a at both ends of each pin hole 3 in joint row link plates 4 are chamfered or rounded. The chamfering or rounding is achieved by a process known as “barreling,” in which the link plates are subjected to polishing by an abrasive medium in a barrelling vessel. Among the types of barreling that can be used are vibration type barreling, in which the barreling vessel is vibrated, fluidizing type barreling, in which a table at the bottom of the barreling vessel is rotated to fluidize the abrasive medium, and centrifugal barreling, in which the barreling vessel is subjected to planetary rotation and revolution. Various hard and soft abrasive materials, of large and small sizes, can be used either alone, or as a mixture.

When the joint row link plates 4 are polished by barreling, edges 3a at both ends of the pin holes 3 are chamfered or rounded, and uneven portions of the inner circumferential surface of the pin holes are removed so that the surface smoothness of the pin hole is improved and leveled and, at the same time, burrs on the teeth and on the back surfaces of the link plates are removed.

Uneven portions of the outer circumferential surfaces of the connecting pins 12 are also removed by barreling, so that the surface smoothness of the pins is improved and leveled. The silent chain 1 is formed by use of the thus barreled joint row link plates 4 and connecting pins 12. The guide row link plates 8 may be also barreled.

As shown in FIG. 1, in a schematically exaggerated manner, when in the joint row link plates 4 tilt with respect to the connecting pins 12, and the silent chain 1 is flexed, edges 3a of the pin holes 3 in the link plates 4 contact the connecting pins 12 as in the case of a conventional silent chain as shown in FIG. 6. However, since the edges 3a of the pin holes 3 are chamfered or rounded, the contact surface is increased, and the surface pressure is reduced. As a result, wear of the connecting pins 12 is reduced, and wear elongation of the chain can be suppressed. Furthermore, when oil is supplied to the chain, even oil which, due to presence of foreign materials such as soot, resists formation of a lubricating film, discharge of the foreign material is improved. Thus the chamfered or rounded edges of the pin holes also reduce wear loss at the pin holes 3 in the connecting pins 12 by improving lubrication.

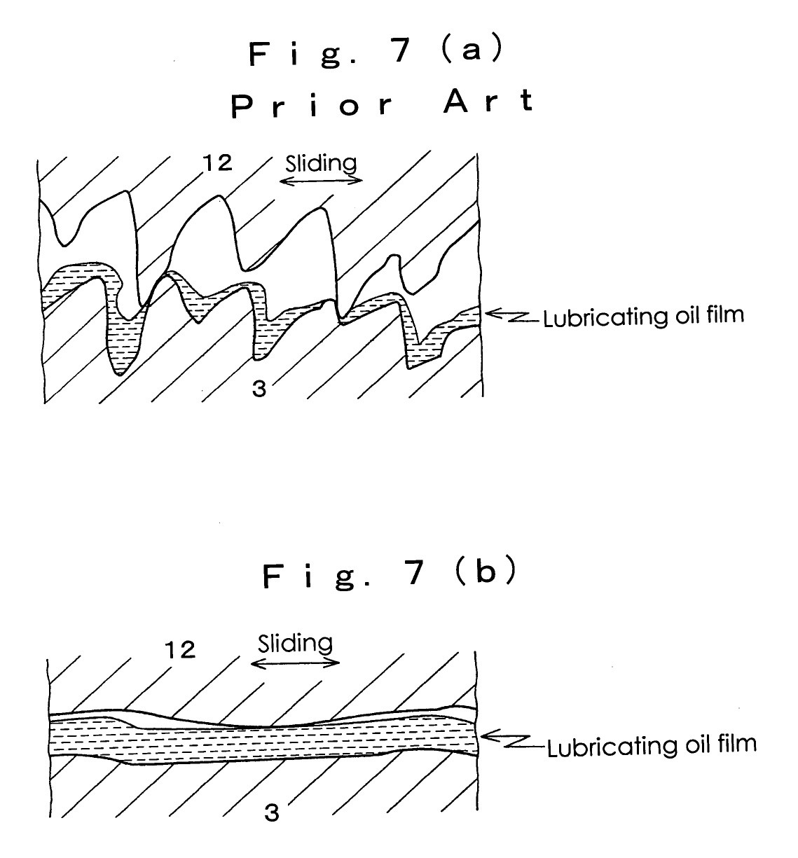

Furthermore, barreling improves the surface smoothness of the inner circumferential surfaces of the pin holes 3 in the joint row link plates 4, and the surface smoothness of the outer circumferential surfaces of the connecting pins 12. Accordingly, when oil is supplied to the silent chain, it readily forms a lubricating oil film, and, as shown in FIG. 7(b), a more uniformly thick lubricating oil film is ensured. The more uniform oil film brings about a lubricating condition in which the pin holes 3 and connecting pins 12 do not contact each other directly, but instead contact each other indirectly through the oil film. Thus wear losses of the both the pins and the pin holes are reduced, and wear elongation of the chain is suppressed.

I claim:

1. A silent chain in which joint row link plates, each having a pair of teeth and pin holes, are disposed in joint link rows, guide row link plates, each having a pair of teeth and pin holes, are disposed in guide link rows, guide plates, each having a pair of pin holes, are disposed at opposite ends of each guide link row, and the link plates of the joint link rows and the plates of the guide link rows are interleaved, and connected, by connecting pins disposed in said pin holes, to form a chain in the form of an endless loop, wherein the pin holes of the joint row link plates have inner circumferential surfaces with opposite ends in the form of circular edges, and said circular edges are chamfered or rounded.

2. A silent chain according to claim 1 in which the surface roughness of the inner circumferential surfaces of the pin holes of the joint row link plates is reduced by barrelling, and the surface roughness of the outer circumferential surfaces of the connecting pins is also reduced by barreling.

3. A silent chain according to claim 1, in which said circular edges at both ends of each pin hole are chamfered or rounded by barreling of the link plates.

4. A silent chain according to claim 3, in which the surface roughness of the inner circumferential surfaces of the pin holes of the joint row link plates is reduced by barrelling, and the surface roughness of the outer circumferential surfaces of the connecting pins is also reduced by barreling.

5. A method of making a silent chain comprising chamfering or rounding the ends of pin holes in link plates by barrelling, and incorporating said link plates, as joint row link plates, into a silent chain.
